(19) United States
(12) Patent Application Publication
(10) Pub. No.: US 2006/0218204 A1
(43) Pub. Date: Sep. 28, 2006

(54) Log stream validation in log shipping data replication systems

(75) Inventors: Effi Ofer, Thornhill (CA); David MacKay Mooney, Toronto (CA); Steven Robert Pearson, Portland, OR (US); Xun Xue, Markham (CA); Kevin James Cherkauer, Portland, OR (US)

Correspondence Address: SUGHRUE MION PLLC;USPTO CUSTOMER NO WITH IBM/SVL, 2100 PENNSYLVANIA AVENUE, N.W., WASHINGTON, DC, 20037, US

(73) Assignee: International Business Machines Corporation

(21) Appl. No.: 11/089,993

(22) Filed: Mar. 25, 2005

(51) Int. Cl. G06F 17/30

(52) U.S. Cl. 707/201

(57) ABSTRACT

A data processing implemented method and system and article of manufacture are provided for determining compatibility between a primary instance and a standby instance, the primary instance being characterized by a first log position indicator and a primary log chain fingerprint (FP-P) and the secondary instance being characterized by a second log position indicator and a secondary log chain fingerprint (FP-S); the FP-P and the FP-S each uniquely identifying a prescribed history of an associated data processing system. The method, for example, includes a series of steps comprising: comparing the first log position indicator with the second log position indicator to determine compatibility between the secondary instance and the primary instance; comparing the primary log chain fingerprint (FP-P) with the secondary log chain fingerprint (FP-S) to determine compatibility between the secondary instance and the primary instance; and indicating that the secondary instance is compatible with the primary instance when both of the above comparisons determine compatibility.

### FIELD OF THE INVENTION

The present invention relates to the field of log shipping data replication and more particularly to log stream validation methods and systems in log shipping data replication systems (such as in database systems, journaled file systems and the like).

### BACKGROUND

In the context of database systems, log-shipping data replication is a process used by database management systems (DBMSs) to increase availability of a database to client applications. A primary DBMS, associated with a primary instance of the database (i.e., a primary database), transfers copies of log records (i.e., logged operations that were performed by the primary DBMS on the primary database) associated with the primary database to a secondary instance of the database (i.e., a secondary database). A secondary DBMS, associated with the secondary database, replays the logged operations by way of known database recovery operations, such as crash recovery or roll-forward recovery methods. Note that a secondary instance is sometimes referred to as a “standby” instance, and the terms “secondary” and “standby” are used interchangeably herein.

The secondary instance of the database is typically unavailable for update during normal operation, but can take over and act as the primary instance of the database in case of a failure of the original primary instance of the database. The database (as far as the end user is concerned) is generally available as long as either site is functioning properly, and the presence of both the primary and the secondary instances of the database provides protection against a potential failure that may be experienced with either the primary and secondary instances of the database. In log shipping data replication, participating systems must have compatible copies of the affected data/databases at the time when log shipping and replay operations begin. If this is not the case, the following kinds of unwanted events may occur: log replay may explicitly fail; log replay may silently corrupt one of the instances of the database; or certain historical changes may be missing from one of the database instances.

Compatibility problems in the area of log shipping data replication arise from certain operations or circumstances, including: (a) roll forward recovery of the primary instance to a point in time that is earlier than the last log position replayed at the secondary instance; (b) crash recovery of the primary instance that fails to reapply all previously logged operations due to corrupt or missing log data; (c) wrong log files (or portions thereof) applied to the secondary instance; and (d) data modifications made independently on the secondary instance.

There is a need to provide log stream validation methods and systems in log shipping data replication systems to detect these problems.

### SUMMARY

Exemplary embodiments of the present invention provide log stream validation methods and systems in log shipping data replication systems. These embodiments of the present invention use a combination of log chain fingerprint and log position validations to; for example, determine if a database state at a secondary instance is compatible with that on a primary instance. Further embodiments of the present invention implement log position validation by using the log position of the end of a recovery of a primary instance after disconnection from a secondary instance. This particular implementation catches cases that using only current log position would not catch. Further embodiments of the present invention implement a log chain fingerprint comparison technique for validating that two databases are using the same log chain. This particular implementation includes comparisons of overlapping truncation points (defined and discussed in detail below), if any, in two log chain fingerprints, together with a comparison of a current log position of the secondary instance with the log position of the first truncation point not found on the secondary. In general, the use of a combination of a log position comparison and a log chain fingerprint comparison achieves a more comprehensive compatibility validation.

In accordance with one aspect of the present invention there is provided a data processing implemented method for determining compatibility between a primary instance and a standby instance, the primary instance being characterized by a first log position indicator and a primary log chain fingerprint (FP-P) and the secondary instance being characterized by a second log position indicator and a secondary log chain fingerprint (FP-S); the FP-P and the FP-S each uniquely identifying a prescribed history of an associated data processing system; said method comprising: comparing the first log position indicator with the second log position indicator to determine compatibility between the secondary instance and the primary instance; comparing the primary log chain fingerprint (FP-P) with the secondary log chain fingerprint (FP-S) to determine compatibility between the secondary instance and the primary instance; and indicating that the secondary instance is compatible with the primary instance when both of the above comparisons determine compatibility.

In accordance with another aspect of the present invention there is provided a data processing system for determining compatibility between a primary instance and a standby instance, the primary instance being characterized by a first log position indicator and a primary log chain fingerprint (FP-P) and the secondary instance being characterized by a second log position indicator and a secondary log chain fingerprint (FP-S); the FP-P and the FP-S each uniquely identifying a prescribed history of an associated data processing system; said method comprising: a module for comparing the first log position indicator with the second log position indicator to determine compatibility between the secondary instance and the primary instance; a module for comparing the primary log chain fingerprint (FP-P) with the secondary log chain fingerprint (FP-S) to determine compatibility between the secondary instance and the primary instance; and a module for indicating that the secondary instance is compatible with the primary instance when both of the above comparisons determine compatibility.

In accordance with another aspect of the present invention there is provided an article of manufacture for determining compatibility between a primary instance and a standby instance, the primary instance being characterized by a first log position indicator and a primary log chain fingerprint (FP-P) and the secondary instance being characterized by a second log position indicator and a secondary log chain fingerprint (FP-S); the FP-P and the FP-S each uniquely identifying a prescribed history of an associated data processing system, the article of manufacture comprising a program usable medium embodying one or more executable data processing system instructions, the executable data processing system instructions comprising: executable data processing system instructions for comparing the first log position indicator with the second log position indicator to determine compatibility between the secondary instance and the primary instance; executable data processing system instructions for comparing the primary log chain fingerprint (FP-P) with the secondary log chain fingerprint (FP-S) to determine compatibility between the secondary instance and the primary instance; and executable data processing system instructions for indicating that the secondary instance is compatible with the primary instance when both of the above comparisons determine compatibility.

### BRIEF DESCRIPTION OF THE DRAWINGS

FIG. 1 is a schematic representation of a system used to implement log stream validation in log shipping data replication systems according to an embodiment of the present invention;

FIG. 2 is a flow chart illustrating a log shipping data replication connection or reconnection operation according to an embodiment of the present invention;

FIG. 3 is a flow chart illustrating a database compatibility check as directed by the operation of FIG. 2 according to an embodiment of the present invention;

FIG. 4 is a flow chart illustrating a log chain fingerprint comparison operation according to an embodiment of the present invention;

FIG. 5 is a flow chart illustrating a prescribed truncation point locating operation as directed by the operation of FIG. 4 according to an embodiment of the present invention;

FIG. 6 is a flow chart illustrating a log chain fingerprint comparison operation according to an embodiment of the present invention;

FIGS. 7A to 7E are schematic representations of log chain fingerprint examples;

FIG. 8 are schematic representations of logs and log files as illustrative examples of various embodiments of the present invention; and

FIG. 9 are schematic representations of logs and log files as illustrative examples of various embodiments of the present invention.

### DETAILED DESCRIPTION

Log shipping data replication are generally deployed in conjunction with database systems but can also be deployed in conjunction with journaled file systems. The subsequent description will deal primarily in the domain of database systems.

Log sequence numbers (LSN); log chain fingerprints (FP); and truncation points (TP) By way of background and to provide context for subsequent description of the embodiments of the present invention the concepts of log sequence numbers, log chain fingerprints, and truncation points will be briefly described.

An LSN is generally defined as a unique key for each log record in a database system. Since an LSN is continuously increasing, it can also be used as an indication of the amount of activity that has occurred in a database (i.e., a type of usage indicator.)

An LSN is a value having no units. An LSN increases in magnitude in proportion to the number or cumulative size of entries made into a log. Consider the LSN to be like a taxi cab meter that cannot be reset. The log is a queue of transactions either executed or to be executed by a database management system. The database management system updates the log. The LSN is an example of a metric that is proportional to the usage of the database management system. Therefore, in effect, each time the database management system receives a transaction to be processed against a database, the LSN of that database is increased and the transaction is recorded in the log. As an example, on Tuesday, the LSN may have a value of 100, while on Wednesday the LSN may have a value of 250 because the database management system executed several transactions against the database.

A log sequence number or LSN is one mechanism to indicate log position. There are other indicators of log position that could equally apply to the various embodiments of the present invention such as byte offset, record number and the like.

Some DBMSs create opportunities for there to be more than one possible log history for a database. This occurs due to several factors, including (a) a possibility that a database is recreated from scratch and starts over with a new, empty log history, and (b) some implementations truncate log data when a point in time recovery is performed. In each case, there may be alternative examples of any particular log file or related chain of log files for the database. It is important that only operations from the correct chain of log files (i.e., the same one used by the primary database) are applied to the secondary database. If that is not the case, the secondary database may become incompatible with the primary database.

A log chain “fingerprint” is any collection of data that intends to uniquely identify a log chain, i.e., a specific path through various portions of the historical database log. Typically, database logs are stored as a sequence of log files. These log files make convenient units of storage and maintenance for the database log, for example, log data is typically transferred (archived, restored) in log file units. Because log files are the typical unit of managing log data, alternative versions of history for a database would typically be identified by reference to which versions of particular log files were applied. Thus, a log chain fingerprint should contain items of log metadata that would serve to uniquely identify which versions of log files correspond to the intended database state.

It is not necessary to include in the log chain fingerprint any metadata for log files for which only one version exists in all possible database histories. In an embodiment of the present invention, the log chain fingerprint is composed of information only about turning points in the database history, i.e., positions in the log where a divergence occurred or may have occurred. The turning points are referred to as “truncation points” (TPs) because divergence is implemented by truncating all existing log data after the turning point.

Other possible log chain fingerprints that could be used would store other kinds of log file metadata that could be used to uniquely identify a log chain. An example of kinds of log file metadata include: LAST MODIFIED TIME (“lastmodtime”) plus LOG FILE SIZE for each log file. If the lastmodtime is accurately maintained by an implementation (in particular, reflecting only active log write activity and not after-the-fact activities such as log file restore or changes to permissions, etc.) then it could be used by itself to construct a very reliable log chain fingerprint, since different possible versions of a given log file would almost certainly have been last updated at different times.

Including log file size is not per se required but it can be included as a double check, or because lastmodtime may not be quite as reliable as one would like in some implementations. There could be other kinds of data used for this as well. Some implementations store a creation timestamp with each log file and update same when a divergence occurs in that log file. The collection of creation times can be used in a fashion quite like lastmodtime could be used to distinguish among alternative versions of the same named/numbered log file. In addition, similar to the approach described above for an embodiment using truncation points, such alternative implementations could also condense the fingerprint information by saving information only for log files in which a divergence actually occurred, thus not crowding the fingerprint with data that is not actually useful during fingerprint comparison operations.

In addition to recording the necessary data in a log chain fingerprint, a DBMS must also ensure that the fingerprint is recoverable along with the associated database, for both normal database recovery and in the context of log shipping data replication. The following steps are required to maintain a log chain fingerprint during recovery or log shipping data replication:
(1) When a database is backed up, store a copy of the log chain fingerprint with the other metadata in the backup image of the database;
(2) When a database is restored, retrieve a copy of the log chain fingerprint from the metadata in the backup image of the database and write same to the appropriate location in the target (being restored) copy of the database; and
(3) When a log file metadata update is encountered during log replay, update the log chain fingerprint, if necessary, based on updated log file metadata information. For example, if truncation points are used in the fingerprint, update the fingerprint with new truncation point information when the metadata received indicates that a log file was truncated.
   Compatibility

Compatible means that the contents of the secondary database, including associated database objects and associated database log are, logically or physically, substantially identical to the primary database as of the point in the primary database's log stream where log shipping data replication is to begin or resume. “Substantially identical” is defined as identical to the extent that the specific log shipping data replication implementation requires and maintains identical instances of the database.

The contents of the database reflect its initial state plus all operations later applied to the database. At any given time, the contents of the primary and secondary databases in a log shipping data replication scheme are likely to be different, because the secondary database may lag behind the primary database. The primary and secondary database need not contain substantially identical database components at the moment of validation; rather, in order to be compatible, after replaying any particular operation, the secondary database must be substantially identical to the contents of the primary database as the primary database existed after the primary database performed that same operation.

Since a history of modifications to the primary database is reflected in a database log, for practical purposes the points in that history are identified by referencing an associated log position. Thus, the compatibility requirement can be restated as follows: before starting or resuming log shipping and replay with respect to the secondary database in a log shipping data replication operation, the database state on that secondary database must be substantially identical to the state on the primary database as the primary database existed at some previous or current point in time as reflected in the primary logs. Successive changes to the database reflect what happened on the primary database after the log position of a validation operation, and thus should keep the secondary database compatible with the primary database over time.

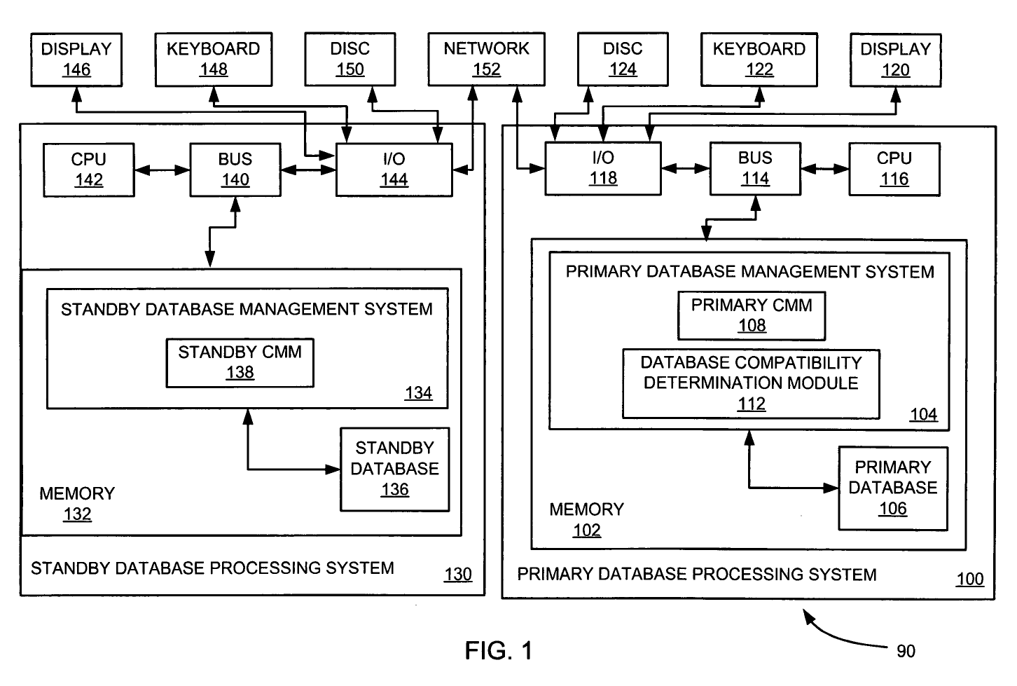

### FIG. 1: SYSTEM

FIG. 1 illustrates a system 90 used to implement log stream validation in log shipping data replication systems according to various embodiments of the present invention. The system 90 includes a primary data processing system 100 operationally coupled through a network 152 to a standby data processing system 130. The primary system 100 includes a bus 114, CPU 116 and input/output interfaces 118. The standby system 130 also includes a bus 140, CPU 142 and input/output interfaces 144. Interface 118 interacts with a display unit 120, a keyboard 122, and a disc unit 124. Interface 144 interacts with a display unit 146, a keyboard 148, and a disc unit 150.

The primary data processing system 100 also includes a memory 102, which includes a primary database 106 operationally coupled to a primary database management system (DBMS) 104 (also referred to more generically as a primary instance). The primary DBMS 104 includes a primary connection management module (CMM) 108 and a database compatibility determination module 112. The standby data processing system 130 includes a memory 132, which includes a standby database 136 operationally coupled to a standby database management system (DBMS) 134 (also referred to more generically as a secondary instance). The standby DBMS 134 includes a standby connection management module (CMM) 138.

The primary DBMS 104 produces a log to keep an ongoing record of transactions executed against the primary database 106. Periodically, the primary DBMS 104 transmits (through the network 152) a portion of the log to the standby DBMS 134 that will then read the transmitted log data and update the standby database 136. The log is a record of all changes made to the primary database 106.

The database compatibility determination module 112 includes computer executable code for providing an indication of whether the primary database 106 and the standby database 136 are substantially identical (as defined above) at some past point in time or at a current point in time.

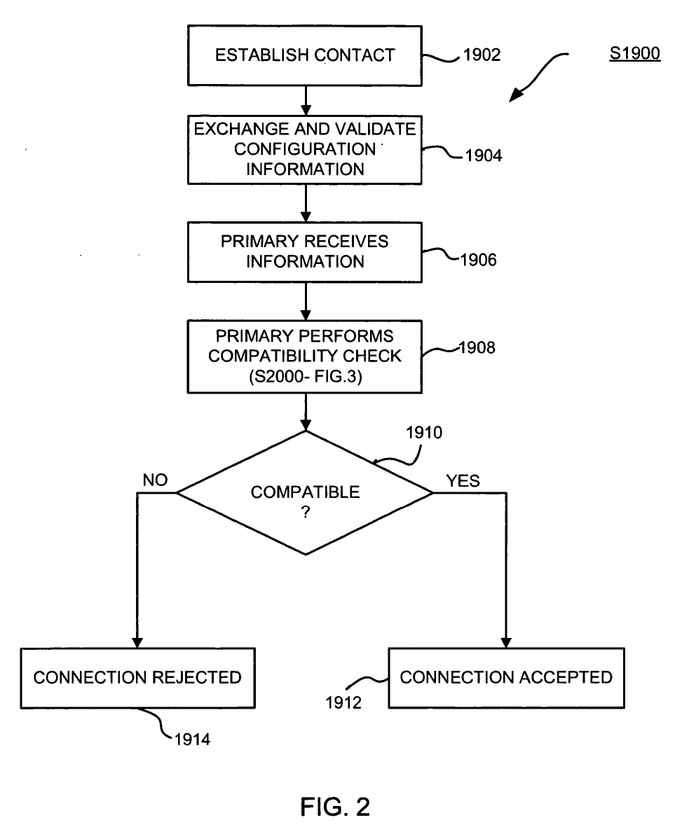

### FIG. 2: METHOD—LOG SHIPPING DATA REPLICATION

FIG. 2 is a flow chart illustrating a log shipping data replication connection or reconnection operation S1900 according to an embodiment of the present invention. The operation S1900 begins with step 1902 where the primary DBMS instance 104 and the standby DBMS instance 134 establish contact (for an initial connection or for a reconnection attempt), via their respective connection management modules (CMMs) 108 (primary) and 138 (standby)), over the network 152.

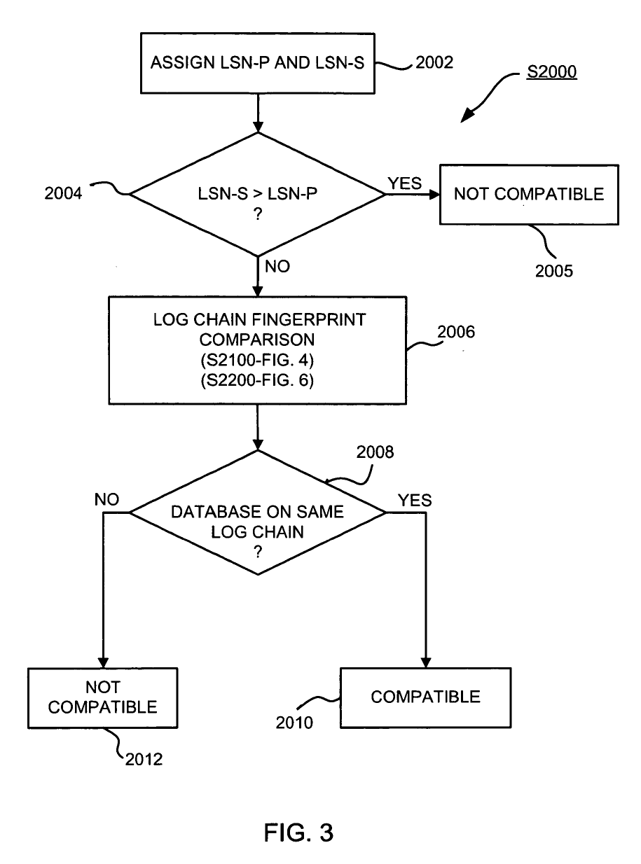

The primary CMM 108 and the standby CMM 138 exchange and validate configuration information at step 1904. The primary CMM 108 receives the current LSN and log chain fingerprint from the standby CMM 138 at step 1906. At step 1908, the primary CMM 108 performs a compatibility check between the primary's current LSN and log chain fingerprint and those of the standby database (obtained at step 1906). Refer to operation S2000 (FIG. 3) for details of the compatibility check step 1908. If the databases (primary and standby) are compatible (step 1910) then the primary CMM 108 returns a connection accepted message to the standby CMM 138 at step 1912, and the DBMSs 104 and 134 begin (or resume) log shipping data replication. If the databases (primary and standby) are not compatible (step 1910) then the primary CMM 108 writes informational messaging to an administrative message log and returns a connection rejection message to the standby CMM 138 at step 1914.

### FIG. 3: COMPATIBILITY CHECK (DETAILS OF STEP 1908 OF FIG. 2)

FIG. 3 is a flow chart illustrating a database compatibility operation S2000 as directed by the operation S1900 of FIG. 2 (refer to step 1908). Operation S2000 begins at step 2002 where LSN-P is assigned a “comparison LSN” of the primary database 106 and LSN-Sis assigned a current LSN (i.e., an end of log position) of the standby database 136. The comparison LSN is an LSN maintained in stable storage (e.g., on disc unit 124) by the primary instance. Upon disconnection from a standby instance, the primary instance stores as the comparison LSN a log position after which it can be certain that the standby instance cannot have received any log data from the primary instance and still be substantially identical to the primary instance.

In an embodiment of the present invention, the comparison LSN is generally set to reflect the current end of log position of the primary instance at the time of disconnection. It is expected that the standby instance should not have any later log when it next communicates with the primary instance. When the disconnection is due to a failure of the primary instance, the comparison LSN is set to the log position at the end of a redo phase of the primary instance's subsequent crash recovery processing. In the case where a prior standby instance becomes a primary instance in a failover or role switch, the comparison LSN is set to the log position of the last log data the old standby instance received before it became the new primary instance. In case there was no prior connection between the primary and standby instances, and thus no comparison LSN was stored, the primary instance's current end of log position is used.

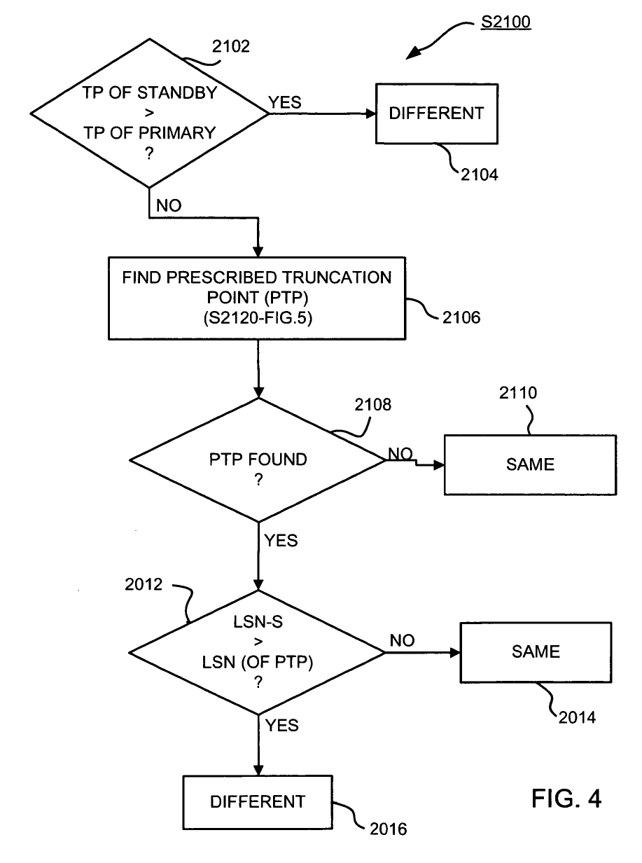

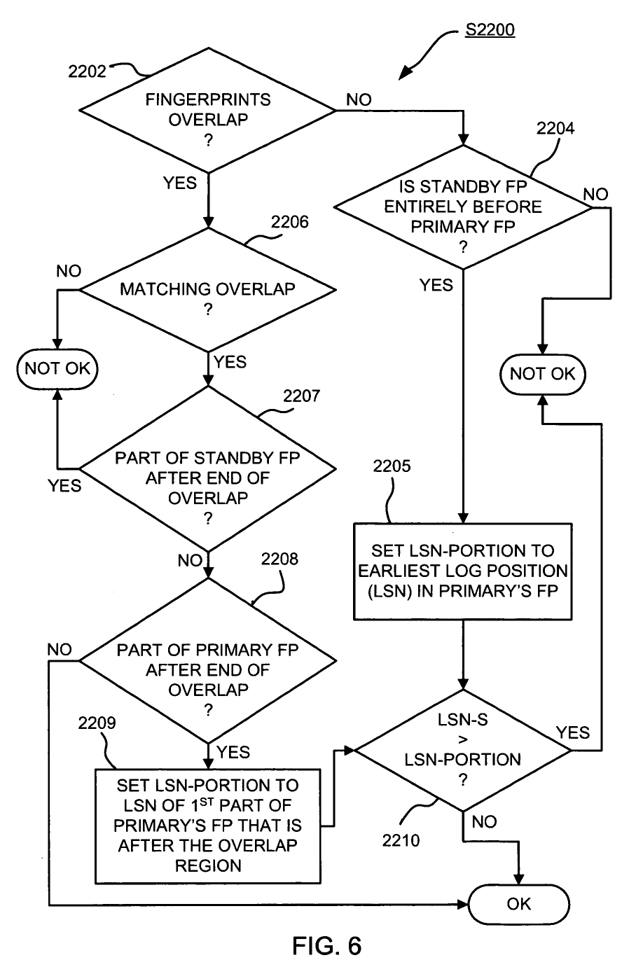

If the LSN-Sis greater than the LSN-P (as determined at step 2004) then the databases are not compatible 2005. If the LSN-Sis less than or equal to the LSN-P then processing continues to step 2006 where the primary database 106 performs a log chain fingerprint comparison (either one of operation S2100—FIG. 4 or operation S2200—FIG. 6; these are alternative embodiments). If the databases are on the same log chain (step 2008) then the databases are compatible 2010. If the databases are not on the same log chain (step 2008) then the database are not compatible 2012.

### FIG. 4: METHOD—LOG CHAIN FINGERPRINT COMPARISON

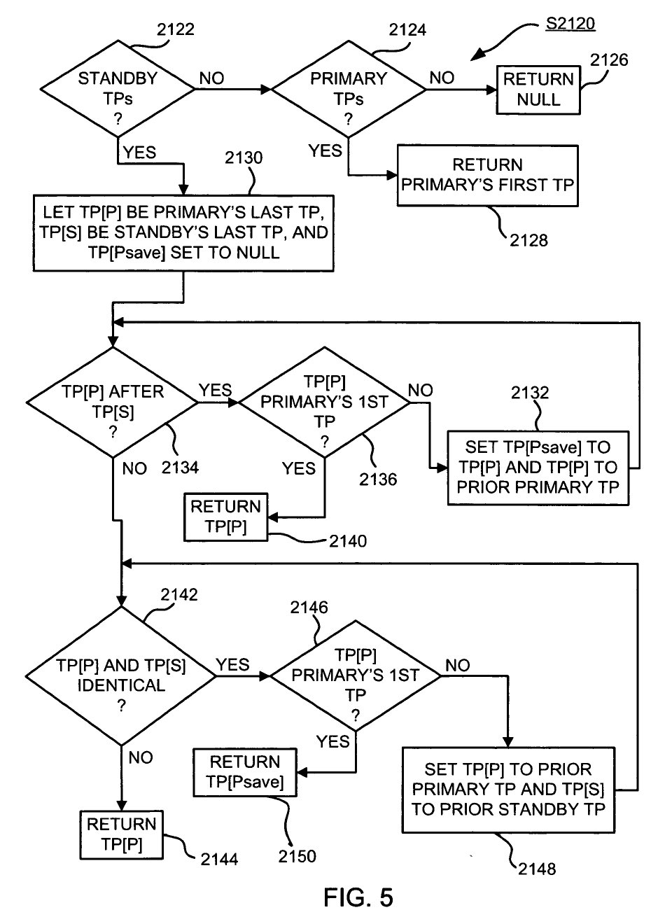

FIG. 4 is a flow chart illustrating a log chain fingerprint comparison operation S2100 (see step 2006 of FIG. 3) according to an embodiment of the present invention. The operation S2100 begins at step 2102 where truncation points (TP) of the primary and standby databases are compared. If the standby database 136 has more truncation points than the primary database 106 then the databases are not using identical log chains 2104. If the standby database 136 has less than or an equal number of truncation points then processing continues to step 2106 where a prescribed truncation point (PTP) is located (refer to operation S2120—FIG. 5).

In general, the PTP is the first truncation point (in historic order) in the primary database 106 log chain fingerprint for which there is no identical truncation point in the standby database 136 log chain fingerprint. In order to be considered identical, truncation points found in both fingerprints must appear in the same relative order. Step 2108 determines whether or not a PTP was located in step 2106. If a PTP is not located, the log chain fingerprints are identical and the comparison operation S2100 determines in step 2110 that the databases are using the same log chain. If a PTP is found to exist in step 2108, a further comparison step 2012 is performed to ensure that the log chain fingerprint of the standby database 136 is not missing a truncation point that the standby would be expected to contain based on the standby's current LSN. If the current LSN of the standby (LSN-S) is greater than the LSN associated with the PTP, then the standby is missing an expected truncation point and the comparison operation S2100 determines in step 2016 that the standby database is not using the same log chain as the primary database; otherwise, the comparison operation S2100 determines in step 2014 that the standby database is using the same log chain as the primary database.

### FIG. 5: METHOD—FINDING PRESCRIBED TRUNCATION POINT (PTP)

FIG. 5 is a flow chart illustrating a PTP locating operation S2120 (see step 2106 of FIG. 4) according to an embodiment of the present invention. The operation S2120 begins at step 2122 where it is determined if the standby database 136 has any truncation points (TPs). If the standby does not have any truncation points then it is determined if the primary database 106 has any truncation points at step 2124. If both the primary and the standby have no truncation points (as determined at steps 2122 and 2124) then a null is returned at step 2126 to indicate that the PTP was not found. If the primary does have truncation points (as determined at step 2124) and the standby has no TPs (as determined at step 2122) then the first TP of the primary is returned as the PTP at step 2128. When the standby does have TPs (as determined at step 2122) processing continues to step 2130 where a first loop begins by initializing local variables to refer to the last TPs of both primary and standby, and setting an additional local TP[Psave] to an initial value of null. This initialization avoids returning an unknown value of TP[Psave] in some cases at step 2150.

The first loop passes in reverse over any primary TPs that occur after the last standby TP. This non-overlapped portion of the log chain fingerprints (i.e., truncation arrays) does not indicate non-compatibility because additional log activity on the primary past the end of logs on the standby does not render the two systems incompatible. At step 2132, the current TP[P] is after the standby's last TP (based on results of decision steps 2134 and 2136). TP[P] is set as the (next) candidate PTP (stored in TP[Psave]). TP[P] is then moved to the prior TP in the primary's truncation array and another iteration of the first loop is performed by returning to step 2134.

When the TP[P] is the primary's first TP (as determined at step 2136) then there is no overlap between the TPs of the primary and the standby and the first TP of primary is returned as PTP at step 2140.

If the TP[P] is not chronologically after the TP[S] (as determined at step 2134) then the primary and the standby TPs should match (i.e., this should be the last TP in the fingerprint overlap region). A second loop (beginning at step 2142) passes in reverse over the overlap region ensuring all primary and standby TPs do match. If one is found that does not match before running out of primary TPs, we break out of the loop at step 2144. Otherwise, processing continues until the first TP of the primary is reached (as determined at step 2146), and thus, by way of the first and second loops, have passed over all primary TPs.

If the TP[P] is not the primary's first TP (as determined at step 2146) processing passes to step 2148 where processing moves on to the prior TP for both primary and standby and the next iteration of the second loop is performed by returning to step 2142.

If the TP[P] is the primary's first TP (as determined at step 2146) then all overlapping TPs matched, so TP[Psave] is returned as the PTP. At this time, TP[Psave] contains either the first TP on the primary after the overlapped portion of the truncation array, or a value of null to indicate that no PTP was found.

If the standby has a non-matching TP (as determined by a negative result at step 2142) then the current TP[P] is returned as PTP at step 2144. Because the standby's current LSN will be greater than the LSN of this TP (in step 2012), the result will be a determination that the databases are not on the same log chain in step 2016 of FIG. 4.

### FIG. 6: METHOD—GENERAL LOG CHAIN FINGERPRINT COMPARISON

FIG. 6 is a flow chart illustrating a log chain fingerprint comparison operation S2200 (see step 2006 of FIG. 3) according to an embodiment of the present invention. Operation S2200 begins at step 2202 where a comparison of the fingerprints is performed (between the primary database 106 and the standby database 136) to determine if they overlap. If the fingerprints do not overlap (as determined at step 2202) then processing continues to step 2204. Step 2204 determines if the standby fingerprint (FP) is entirely before the primary fingerprint. If the determination at step 2204 is negative (i.e., the standby fingerprint is not entirely before the primary fingerprint) then the comparison ends with a “not ok” determination. If the determination at step 2204 is positive (i.e., the standby fingerprint is entirely before the primary fingerprint) then processing continues to step 2205. At step 2205 a variable (LSN-portion) is set to the earliest log position in the primary's FP. Processing then continues to a comparison step 2210 (discussed in detail below).

Returning to step 2202, if the fingerprints do overlap then processing continues to step 2206 where a determination of whether the overlapping portions match is conducted: with no match the comparison ends with a “not ok” determination; and with a match processing continues to step 2207. At step 2207 it is determined if any part of the standby fingerprint exists after the end of the overlap: if yes then the comparison ends with a “not ok” determination; and if no then processing continues to step 2208. At step 2208 it is determined if any part of the primary fingerprint exists after the end of the overlap: if no then the comparison ends with an “ok” determination, and if yes then processing continues to step 2209. Step 2209 sets a variable (LSN-portion) to the LSN of the first part of the primary's FP that is after the overlap region. After step 2209 processing continues to the comparison step 2210.

Step 2210 compares the LSN-S with the LSN-portion (as set at either step 2205 or step 2209). If LSN-Sis greater than the LSN-portion then the comparison ends with a “not ok” determination. If LSN-Sis less than or equal to the LSN-portion then the comparison ends with an “ok” determination.

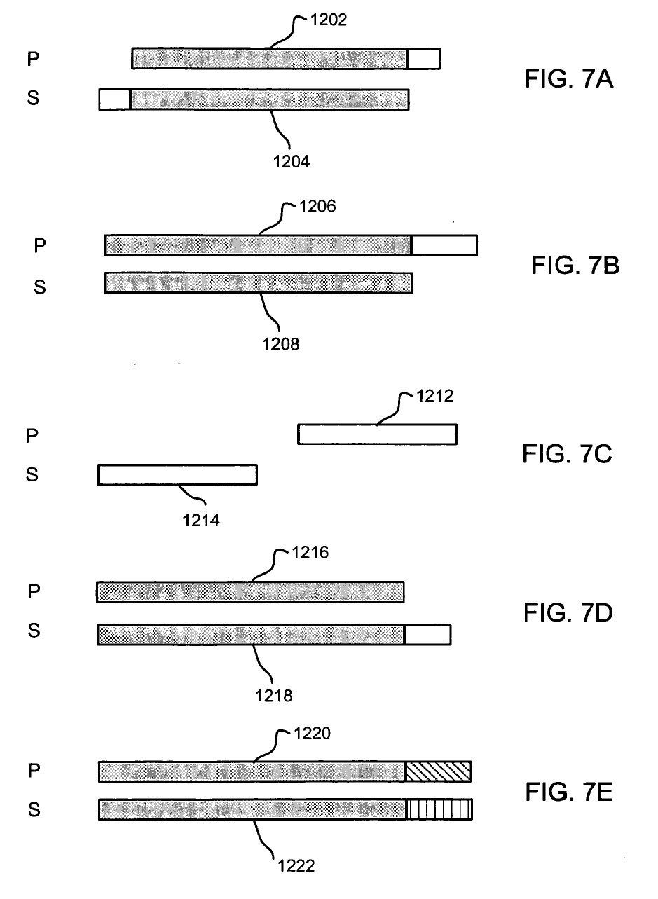

### FINGERPRINT EXAMPLES: FIGS. 7A-E

As discussed above, the compatibility test of certain embodiments of the present invention has two parts: (1) a basic LSN (or log position) comparison test and (2) a log chain fingerprint comparison test. Illustrative examples of the log chain fingerprint comparison are provided in FIGS. 7A-E.

More particularly, as described above, a log chain fingerprint is reflective of a particular history of the database as recorded in the log. The log starts from some origin and grows in a “boundless” fashion. A fingerprint for a database can be pictured as a line segment or bar graph, either growing boundlessly from an origin or bounded by some limit on the size of the fingerprint (e.g., 30 truncation points). This type of representation is useful in making the fingerprint overlap notion more concrete. For example, FIG. 7A illustrates two size-limited fingerprints 1202 and 1204, where the shaded portions indicate the overlapped regions, which are expected to match.

Similarly, FIG. 7B illustrates a comparison between “boundless” fingerprints 1206 and 1208, both starting at an origin. FIG. 7C illustrates non-overlapping fingerprints 1212 and 1214. FIGS. 7D and 7E illustrate pairs of non-compatible fingerprints: pair 1216 and 1218 and pair 1220 and 1222.

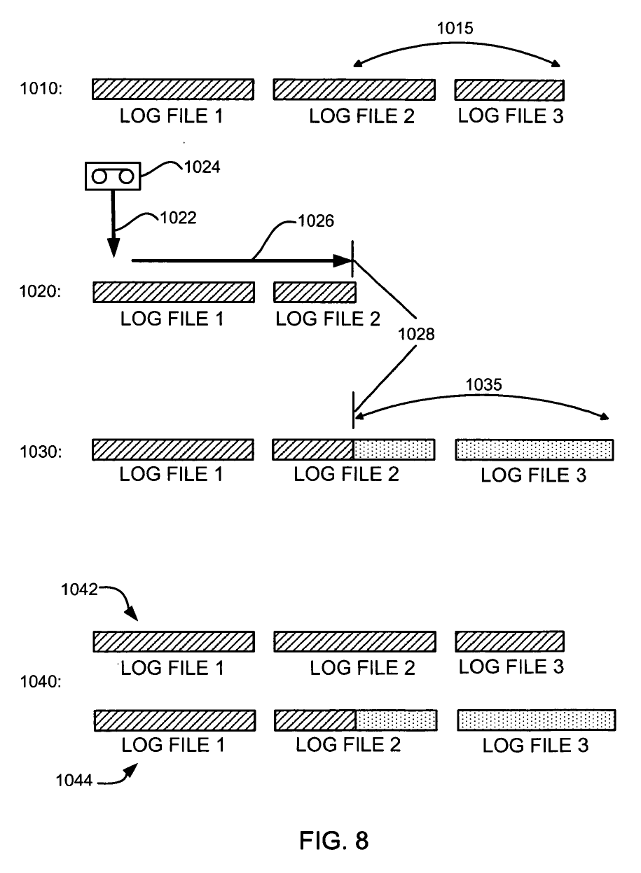

### LOG CHAIN DIVERGENCE—FIG. 8

FIG. 8 illustrates bar graph represents to show one way in which a log chain divergence may occur, leading to multiple possible log histories for a database. In each graphic in FIG. 8 (1010, 1020, 1030, 1040), shaded horizontal bars represent active log files for a database.

Consider a case where an application misbehaves and performs errant updates to the database during a timeframe 1015. In order to remove the errant changes from the database, the database administrator may restore it 1022 from an earlier backup 1024 and then recover (i.e., roll forward) 1026 the database to a point in time 1028 that is prior to where the application began misbehaving. For purposes of exposition, assume this recovery endpoint occurs in log file 2 at LSN 100. During such a recovery operation, the log may be truncated at the indicated point in time. Subsequently, new log data 1035 for the database is generated after the point of truncation, both for compensation log records, if any, from an undo phase of the discussed recovery operation and for new updates to the database that occur after the recovery operation.

The final graphic 1040 illustrates that this scenario results in two possible histories for the database, as reflected in the database's log files: an original log chain 1042 and a subsequent log chain 1044. As long as proper archive copies of the associated log files exist, the user may choose which log chain should apply to the database. A database management system (DBMS) has no mechanism to determine that one or the other of the two log chains is a valid log chain and the other invalid. However, in a log shipping data replication system it would be advantageous for a DBMS to be able to distinguish between the two different log chains.

Consider the previously described scenario when a log shipping data replication system is in use. When the misbehaving application is detected and the above-described response is taken on the primary, log shipping data replication is suspended, at least temporarily. If the standby instance was caught up with the primary instance at the time the repairs began, then the standby's database log will be similar to the primary's original log chain ( 1042), and the standby database's contents will reflect same. After the primary is recovered and restarted, the user may attempt to restart the log shipping data replication system as well. However, since the primary instance had some of its history erased, and the corresponding changes removed from its copy of the database, the standby is not consistent with the primary until some further action is taken.

If the restart is attempted immediately or shortly after the primary is recovered, the DBMS may be able to detect that something is amiss due to the primary's end of log location, which may be at or close to the recovery endpoint (1028) in log file 2, being earlier in the log than the current end of log on the standby, which is in log file 3 (this would be like the case illustrated in FIG. 7D). But if new updates are performed on the primary before the log shipping data replication system is restarted, it is possible that by that time the primary has a log chain similar to the previously discussed subsequent log chain (1040). In this case, the comparison between the end of log positions of the primary and the standby does not by itself indicate any obvious problem, yet the primary and standby are inconsistent with each other.

Various embodiments of the present invention maintain a “fingerprint” that intends to uniquely identify a particular log chain, and a comparison between the log chain fingerprints of the primary and the standby can be used to determine if the primary and standby are using similar or dissimilar log chains. If dissimilar log chains are found, the primary and standby are not consistent with each other and cannot be operated together in a log shipping data replication system.

Potential divergence among log chains occurs whenever existing data in a database log is truncated. Accordingly, an embodiment of the present invention uses an array of information items that describes all recent log truncation events as a log chain fingerprint. Each entry in the truncation array is referred to as a “truncation point.” The truncation points are chronologically ordered. Unused entries are specially marked; in the case of this embodiment they contain data values of zero.

As illustrated in Tables I and II below, the above scenario results in one truncation point being recorded in the log chain for the primary instance, whereas the standby instance has no truncation points recorded.

TABLES I AND II

| | |
|---|---|
| Primary Database | Standby Database |
| Truncation Points | Truncation Points |

| Log File | LSN | Log File | LSN |
|---|---|---|---|
| 0 | 0 | 0 | 0 |
| . . . | . . . | . . . | . . . |
| 0 | 0 | 0 | 0 |
| 2 | 100 | 0 | 0 |

Since in general the primary may be ahead of the standby, the above difference in log chain fingerprints is not sufficient to determine that the databases are inconsistent. Embodiments of the present invention apply one additional test, which is to ensure that the standby is not missing any truncation point that it should have based on its current end of log position. In the above scenario, that test will fail. Because the standby's end of log position is in log file 3, the standby should have the earlier truncation point in log file 2 just as the primary does, if it is using the same log chain as the primary.

The above scenario is one example of a case matching FIG. 7E, where the most recent portion of the log chain fingerprints of the primary and standby do not match, but should.

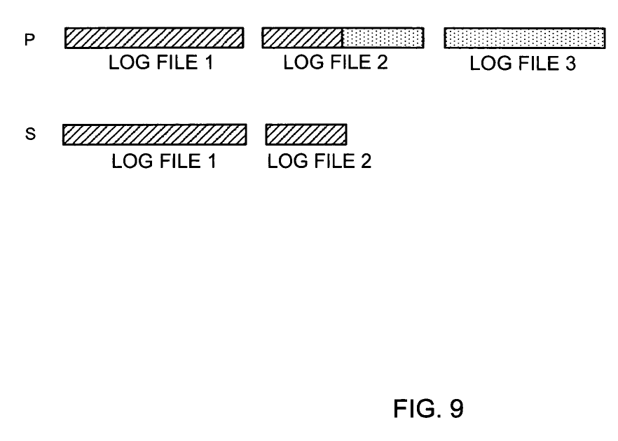

Note that the same fingerprints could occur in a compatible scenario where the standby's end of log position is not past log file 2, LSN 100, as illustrated in FIG. 9, which is an example of the case shown in FIG. 7B. This situation could occur if the standby was not caught up with the primary at the time the log shipping data replication system was suspended, and its end of log position had not yet reached the primary's recovery endpoint.

A further truncation array example is provided in Tables III and IV below.

This example illustrates overlapping, matching, size-limited fingerprints (corresponding to FIG. 7A), in a truncation array (truncation points) embodiment of the present invention.

TABLES III AND IV

| | |
|---|---|
| Primary Database | Standby Database |
| Truncation Points | Truncation Points |

| Log File | LSN | Log File | LSN |
|---|---|---|---|
| 3 | 300 | 2 | 200 |
| 4 | 400 | 3 | 300 |
| 5 | 500 | 4 | 400 |
| . . . | . . . | 5 | 500 |
| 30 | 3000 | . . . | . . . |
| 31 | 3100 | 30 | 3000 |
| 32 | 3200 | 31 | 3100 |

This example illustrates a case where there is a truncation point in each log file from file 2 through file 32. Because the fingerprint is limited to the 30 most recent truncation points, the primary's version retains only the information for the truncation points in log files 3 through 32. Meanwhile, the standby is somewhat behind the primary and its fingerprint records the truncation points for log files 2 through 31. The truncation point information for log files 3 through 31, the overlapped region, matches exactly in the two fingerprints. If the standby's current end of log position is not beyond LSN 3200, the LSN of the primary's first TP after the overlap region, then the log chain comparison will determine that the standby is on the same log chain as the primary.

A summary of the various features of the embodiments of the present invention is provided below:
(a) Each database instance maintains in stable storage a “fingerprint” uniquely reflective of the “log chain” leading up to its current log position. In order to save on disc space consumption, the fingerprint need not be reflective of the entire log chain history (i.e., reaching back to the creation of the database). However, for use in log shipping data replication, it does contain sufficient historical information such that it will be highly likely to include the information relevant to validating the log chain at the current log position of a secondary instance. The fingerprint is updated on a primary instance when an event occurs that has the potential to create a diverging log chain (includes explicit or implicit point in time recovery operations, as well as the endpoint of log replay that occurs on a secondary instance as it transitions to primary role; basically anywhere a rollforward-type recovery operation finishes redo processing). In a log shipping data replication scheme, the fingerprint is updated on a secondary instance as part of maintaining log file specific metadata during log replay.
(b) The fingerprint is composed of an array of fixed size (e.g., 30 entries) of “truncation points.” The array is maintained in a circular fashion should there be more truncation events in the present log chain than will fit in the array. Each truncation point contains a unique identifier for the log file in which a truncation event occurred, as well as the log position of that truncation event within that log file.
(c) When a primary and a secondary database instance in a log shipping data replication scheme establish a connection, either initially or after a prior connection was broken and is being recreated, they perform a set of validations that according to embodiments of the present invention includes a log chain fingerprint validation to ensure that the primary and secondary are each associated with the same log chain. This validation involves matching of the overlapping portions of the fingerprint information discussed in connection with FIGS. 7A-E between the primary and secondary instances.
(d) Fingerprint validation can include verification that all truncation points of the secondary instance that also occur in the primary instance's fingerprint must contain identical information (unique log file identification and truncation point position within same). Note that because the number of truncation points maintained is limited, and the log position of the primary instance may be somewhat ahead of that on the secondary, the primary instance's fingerprint is allowed to contain additional truncation points that occur after the most recent truncation point of the secondary, and the secondary instance's fingerprint is allowed to contain additional truncation points that occur before the oldest truncation point retained in the primary instance's fingerprint.
(e) Fingerprint validation also can include verification that the current log position of the secondary instance is not beyond the log position of the first truncation point in the primary instance's fingerprint, if any, which occurs after the most recent truncation point in the secondary instance's fingerprint. This ensures that the secondary instance has not missed a truncation point that it should contain if it is on the same log chain as the primary instance.
(f) Each primary database instance maintains in stable storage, upon disconnection from a secondary instance, a log position after which it can be certain that the secondary instance cannot have received any log data from the primary and still be substantially identical to the primary.
(g) When a primary and a secondary database instance in a log shipping data replication scheme establish a connection, either initially or after a prior connection was broken and is being recreated, they perform a set of validations that according to this invention includes a log position validation to ensure that the current log position of the secondary instance is less than or equal to that of the log position saved at the primary instance as discussed above.

The detailed description of the various embodiments of the present invention does not limit the implementation of the embodiments of the present invention to any particular computer programming language. The computer program product may be implemented in any computer programming language provided that the OS (Operating System) provides the facilities that may support the requirements of the computer program product. An exemplary embodiment of the present invention can be implemented in the C or C++ computer programming language, or may be implemented in any other mix of supported programming languages. Any limitations presented would be a result of a particular type of operating system, computer programming language, or DBMS and would not be a limitation of the embodiments of the present invention described herein.

It will be appreciated that the elements described above may be adapted for specific conditions or functions. The concepts of the present invention can be further extended to a variety of other applications that are clearly within the scope of this invention. Having thus described the present invention with respect to various embodiments as implemented, it will be apparent to those skilled in the art that many modifications and enhancements are possible to the present invention without departing from the basic concepts as described in the various embodiments of the present invention. Therefore, what is intended to be protected by way of letters patent should be limited only by the scope of the following claims.

1. A data processing implemented method for determining compatibility between a primary instance and a standby instance, the primary instance being characterized by a first log position indicator and a primary log chain fingerprint (FP-P) and the secondary instance being characterized by a second log position indicator and a secondary log chain fingerprint (FP-S); the FP-P and the FP-S each uniquely identifying a prescribed history of an associated data processing system; said method comprising:
comparing the first log position indicator with the second log position indicator to determine compatibility between the secondary instance and the primary instance;
comparing the primary log chain fingerprint (FP-P) with the secondary log chain fingerprint (FP-S) to determine compatibility between the secondary instance and the primary instance; and
indicating that the secondary instance is compatible with the primary instance when both of the above comparisons determine compatibility.

2. The method of claim 1 wherein comparing the first log position indicator with the second log position indicator comprises:
assigning to the first log position indicator a value representing a comparison log position after which the secondary instance cannot have received any log data from the primary instance and still be substantially identical to the primary instance;
assigning to the second log position indicator a value representing a most recent log position from the secondary instance; and
indicating that the primary instance is compatible with the secondary instance when the second log position indicator is less than or equal to the first log position indicator.

3. The method of claim 1 wherein, when the FP-P and the FP-S overlap, comparing the FP-P with the FP-S comprises:
determining that a first condition is true when the overlapped portions of the FP-P and the FP-S are identical;
determining that a second condition is true when no portion of the FP-Sexists after the end of the overlapped portion; and
indicating that the secondary instance is compatible with the primary instance when the first and second conditions are true.

4. The method of claim 3 wherein comparing the FP-P with the FP-S further comprises:
determining that a third condition is true when no part of the FP-P exists after the end of the overlapped portion of the fingerprints;
determining that a fourth condition is true when the second log position indicator is less than or equal to a value representing a log position of the first part of the FP-P that is after the overlapped portion of the fingerprints; and
indicating that the secondary instance is compatible with the primary instance when at least one of the third and fourth conditions is true.

5. The method of claim 1 wherein, when the FP-P and the FP-S do not overlap, comparing the FP-P with the FP-S comprises:
determining that a fifth condition is true when the FP-Sis chronologically entirely before the FP-P; and
indicating that the secondary instance is compatible with the primary instance when the fifth condition is true.

6. The method of claim 5 wherein comparing the FP-P with the FP-S further comprises:
determining that a sixth condition is true when the second log position indicator is less than or equal to a value representing a log position of an earliest portion of the FP-P; and
indicating that the secondary instance is compatible with the primary instance when the sixth condition is true.

7. The method of claim 1 further comprising composing the log chain fingerprints FP-P and FP-S of a fixed size array of truncation points, each of which contains a log file number and a log position indicator, representing a most recent set of log truncation events in a respective instance's log history.

8. The method of claim 2 further comprising saving a comparison log position in a stable storage in the primary instance when no such comparison log position has been saved since the primary instance and the secondary instance were last in communication, including:
saving as the comparison log position a log position of the last log data sent from the primary instance to the secondary instance while the primary instance and the secondary instance were most recently in communication when a primary instance detects disconnection from a secondary instance;
saving as the comparison log position a log position of the end of a redo phase of the primary instance's crash recovery processing when a primary instance first successfully restarts after a failure of the primary instance; and
removing the comparison log position when the primary instance and the secondary instance establish communication.

9. The method of claim 8 wherein assigning to the first log position indicator a value representing a comparison log position further comprises:
assigning to the first log position indicator a value representing the primary instance's current end of log position when there has been no prior connection between the primary and secondary instances; and
assigning to the first log position indicator a value representing the comparison log position from the stable storage in the primary instance when there has been a prior connection between the primary and secondary instances.

10. A data processing system for determining compatibility between a primary instance and a standby instance, the primary instance being characterized by a first log position indicator and a primary log chain fingerprint (FP-P) and the secondary instance being characterized by a second log position indicator and a secondary log chain fingerprint (FP-S); the FP-P and the FP-S each uniquely identifying a prescribed history of an associated data processing system; said method comprising:
a module for comparing the first log position indicator with the second log position indicator to determine compatibility between the secondary instance and the primary instance;
a module for comparing the primary log chain fingerprint (FP-P) with the secondary log chain fingerprint (FP-S) to determine compatibility between the secondary instance and the primary instance; and
a module for indicating that the secondary instance is compatible with the primary instance when both of the above comparisons determine compatibility.

11. The system of claim 10 wherein the module for comparing the first log position indicator with the second log position indicator comprises:
a mechanism for assigning to the first log position indicator a value representing a comparison log position after which the secondary instance cannot have received any log data from the primary instance and still be substantially identical to the primary instance;
a mechanism for assigning to the second log position indicator a value representing a most recent log position from the secondary instance; and
a mechanism for indicating that the primary instance is compatible with the secondary instance when the second log position indicator is less than or equal to the first log position indicator.

12. The system of claim 10 wherein, when the FP-P and the FP-S overlap, the module for comparing the FP-P with the FP-S comprises:
a mechanism for determining that a first condition is true when the overlapped portions of the FP-P and the FP-S are identical;
a mechanism for determining that a second condition is true when no portion of the FP-S exists after the end of the overlapped portion; and
a mechanism for indicating that the secondary instance is compatible with the primary instance when the first and second conditions are true.

13. The system of claim 12 wherein the module for comparing the FP-P with the FP-S further comprises:
a mechanism for determining that a third condition is true when no part of the FP-P exists after the end of the overlapped portion of the fingerprints;
a mechanism for determining that a fourth condition is true when the second log position indicator is less than or equal to a value representing a log position of the first part of the FP-P that is after the overlapped portion of the fingerprints; and
a mechanism for indicating that the secondary instance is compatible with the primary instance when at least one of the third and fourth conditions is true.

14. The system of claim 10 wherein, when the FP-P and the FP-S do not overlap, the module for comparing the FP-P with the FP-S comprises:
a mechanism for determining that a fifth condition is true when the FP-Sis chronologically entirely before the FP-P; and
a mechanism for indicating that the secondary instance is compatible with the primary instance when the fifth condition is true.

15. The system of claim 14 wherein the module for comparing the FP-P with the FP-S further comprises:
a mechanism for determining that a sixth condition is true when the second log position indicator is less than or equal to a value representing a log position of an earliest portion of the FP-P; and
a mechanism for indicating that the secondary instance is compatible with the primary instance when the sixth condition is true.

16. The system of claim 10 further comprising a mechanism for composing the log chain fingerprints FP-P and FP-S of a fixed size array of truncation points, each of which contains a log file number and a log position indicator, representing a most recent set of log truncation events in a respective instance's log history.

17. The system of claim 11 further comprising a mechanism for saving a comparison log position in a stable storage in the primary instance when no such comparison log position has been saved since the primary instance and the secondary instance were last in communication, including:
a mechanism for saving as the comparison log position a log position of the last log data sent from the primary instance to the secondary instance while the primary instance and the secondary instance were most recently in communication when a primary instance detects disconnection from a secondary instance;
a mechanism for saving as the comparison log position a log position of the end of a redo phase of the primary instance's crash recovery processing when a primary instance first successfully restarts after a failure of the primary instance; and
a mechanism for removing the comparison log position when the primary instance and the secondary instance establish communication.

18. The system of claim 17 wherein the mechanism for assigning to the first log position indicator a value representing a comparison log position further comprises:
a mechanism for assigning to the first log position indicator a value representing the primary instance's current end of log position when there has been no prior connection between the primary and secondary instances; and
a mechanism for assigning to the first log position indicator a value representing the comparison log position from the stable storage in the primary instance when there has been a prior connection between the primary and secondary instances.

19. An article of manufacture for determining compatibility between a primary instance and a standby instance, the primary instance being characterized by a first log position indicator and a primary log chain fingerprint (FP-P) and the secondary instance being characterized by a second log position indicator and a secondary log chain fingerprint (FP-S); the FP-P and the FP-S each uniquely identifying a prescribed history of an associated data processing system, the article of manufacture comprising a program usable medium embodying one or more executable data processing system instructions, the executable data processing system instructions comprising:
executable data processing system instructions for comparing the first log position indicator with the second log position indicator to determine compatibility between the secondary instance and the primary instance;
executable data processing system instructions for comparing the primary log chain fingerprint (FP-P) with the secondary log chain fingerprint (FP-S) to determine compatibility between the secondary instance and the primary instance; and
executable data processing system instructions for indicating that the secondary instance is compatible with the primary instance when both of the above comparisons determine compatibility.

20. The article of claim 19 wherein the executable data processing system instructions for comparing the first log position indicator with the second log position indicator comprises:
executable data processing system instructions for assigning to the first log position indicator a value representing a comparison log position after which the secondary instance cannot have received any log data from the primary instance and still be substantially identical to the primary instance;
executable data processing system instructions for assigning to the second log position indicator a value representing a most recent log position from the secondary instance; and
executable data processing system instructions for indicating that the primary instance is compatible with the secondary instance when the second log position indicator is less than or equal to the first log position indicator.

21. The article of claim 19 wherein, when the FP-P and the FP-S overlap, the executable data processing system instructions for comparing the FP-P with the FP-S comprise:
executable data processing system instructions for determining that a first condition is true when the overlapped portions of the FP-P and the FP-S are identical;
executable data processing system instructions for determining that a second condition is true when no portion of the FP-Sexists after the end of the overlapped portion; and
executable data processing system instructions for indicating that the secondary instance is compatible with the primary instance when the first and second conditions are true.

22. The article of claim 21 wherein the executable data processing system instructions for comparing the FP-P with the FP-S further comprise:
executable data processing system instructions for determining that a third condition is true when no part of the FP-P exists after the end of the overlapped portion of the fingerprints;
executable data processing system instructions for determining that a fourth condition is true when the second log position indicator is less than or equal to a value representing a log position of the first part of the FP-P that is after the overlapped portion of the fingerprints; and
executable data processing system instructions for indicating that the secondary instance is compatible with the primary instance when at least one of the third and fourth conditions is true.

23. The article of claim 19 wherein, when the FP-P and the FP-S do not overlap, the executable data processing system instructions for comparing the FP-P with the FP-S comprise:
executable data processing system instructions for determining that a fifth condition is true when the FP-Sis chronologically entirely before the FP-P; and
executable data processing system instructions for indicating that the secondary instance is compatible with the primary instance when the fifth condition is true.

24. The article of claim 23 wherein the executable data processing system instructions for comparing the FP-P with the FP-S further comprise:
executable data processing system instructions for determining that a sixth condition is true when the second log position indicator is less than or equal to a value representing a log position of an earliest portion of the FP-P; and
executable data processing system instructions for indicating that the secondary instance is compatible with the primary instance when the sixth condition is true.

25. The article of claim 19 further comprising executable data processing system instructions for composing the log chain fingerprints FP-P and FP-S of a fixed size array of truncation points, each of which contains a log file number and a log position indicator, representing a most recent set of log truncation events in a respective instance's log history.

26. The article of claim 20 further comprising executable data processing system instructions for saving a comparison log position in a stable storage in the primary instance when no such comparison log position has been saved since the primary instance and the secondary instance were last in communication, including:
executable data processing system instructions for saving as the comparison log position a log position of the last log data sent from the primary instance to the secondary instance while the primary instance and the secondary instance were most recently in communication when a primary instance detects disconnection from a secondary instance;
executable data processing system instructions for saving as the comparison log position a log position of the end of a redo phase of the primary instance's crash recovery processing when a primary instance first successfully restarts after a failure of the primary instance; and
executable data processing system instructions for removing the comparison log position when the primary instance and the secondary instance establish communication.

27. The article of claim 26 wherein the executable data processing system instructions for assigning to the first log position indicator a value representing a comparison log position further comprise:
executable data processing system instructions for assigning to the first log position indicator a value representing the primary instance's current end of log position when there has been no prior connection between the primary and secondary instances; and
executable data processing system instructions for assigning to the first log position indicator a value representing the comparison log position from the stable storage in the primary instance when there has been a prior connection between the primary and secondary instances.
